(19) United States
(12) Patent Application Publication
(10) Pub. No.: US 2026/0178440 A1
(43) Pub. Date: Jun. 25, 2026

(54) DYNAMIC RECONFIGURATION OF ERROR CONTROL OPERATIONS

(71) Applicant: Micron Technology, Inc., Boise, ID (US)

(72) Inventors: Nicola Corna, Gorle (BG) (IT); Nicola Del Gatto, Cassina de' Pecchi (IT); Marco Sforzin, Cernusco Sul Naviglio (MI) (IT)

(21) Appl. No.: 19/399,374

(22) Filed: Nov. 24, 2025

Related U.S. Application Data
(60) Provisional application No. 63/737,364, filed on Dec. 20, 2024.

(51) Int. Cl. G06F 11/10

(52) U.S. Cl. CPC G06F 11/1016; G06F 11/1048

(57) ABSTRACT

Methods, systems, and devices for dynamic reconfiguration of error control operations are described. A memory system may configure ranks of the memory system to operate according to a single die data correction (SDDC) code. In the case that the memory system may determine that a memory die of one of the ranks may include an error, the memory system may reconfigure a first virtual bank of the rank and a second virtual bank of a second rank to operate according to a double die data correction (DDDC) code. The memory system may reconfigure the virtual banks of the ranks to operate according to a quadruple die data correction (QDDC) code in the case that further errors may be detected at the virtual banks, and may refrain from reconfiguring virtual banks that may not be associated with or adjacent to a memory die including an error.

### CROSS REFERENCE

The present Application for Patent claims priority to U.S. Patent Application No. 63/737,364 by Corna et al., entitled “DYNAMIC RECONFIGURATION OF ERROR CONTROL OPERATIONS,” filed Dec. 20, 2024, which is assigned to the assignee hereof, and which is expressly incorporated by reference in its entirety herein.

### TECHNICAL FIELD

The following relates to one or more systems for memory, including dynamic reconfiguration of error control operations.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports dynamic reconfiguration of error control operations in accordance with examples as disclosed herein.

FIGS. 2 and 3 show examples of block diagrams that support dynamic reconfiguration of error control operations in accordance with examples as disclosed herein.

FIG. 4 shows an example of a process flow that supports dynamic reconfiguration of error control operations in accordance with examples as disclosed herein.

FIG. 5 shows a block diagram of a memory system that supports dynamic reconfiguration of error control operations in accordance with examples as disclosed herein.

FIGS. 6 and 7 show flowcharts illustrating a method or methods that support dynamic reconfiguration of error control operations in accordance with examples as disclosed herein.

### DETAILED DESCRIPTION

Some memory systems may include components, such as memory dies, that may be manufactured using relatively lower quality materials. The use of relatively lower quality materials may decrease production costs of the memory system, such materials may also result in the associated component(s) being more susceptible to a relatively higher quantity of errors. To account for and decrease such errors, the memory system may be configured to implement relatively aggressive error control capabilities using various error control codes (ECCs). For example, a memory system may implement a double data die correction (DDDC) capability, which may improve the memory system's overall error detection and correction capability but may decrease the bandwidth and overall performance of the memory system. Accordingly, a memory system configured to dynamically reconfigure error control capabilities with the drawbacks of other different systems may be desirable.

A memory system configured to dynamically reconfigure error control capabilities is described herein. For example, a memory system may configure ranks (e.g., regions of memory dies) to operate according to a capability, such as a single die data correction (SDDC) capability. In the case that the memory system determines that a memory die associated with a virtual bank (e.g., portions of the memory dies included in the respective ranks) of one of the ranks includes an error, the memory system may reconfigure one or more virtual banks (e.g., two or more virtual banks in total) to operate according to a DDDC capability. In some examples, if the memory system determines that multiple memory dies (e.g., configured using a DDDC capability) include errors, the memory system may reconfigure two or more additional virtual banks (e.g., four virtual banks in total) to operate according to a quad die data correction (QDDC) capability. By dynamically reconfiguring virtual banks of a memory system in response to detecting errors at associated memory dies, the memory system may increase its ability to detect and correct errors, while also maintaining a relatively higher bandwidth and overall performance, among other benefits.

In addition to applicability in memory systems as described herein, techniques for dynamic reconfiguration of error control operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively higher processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques for dynamic reconfiguration of error control operations may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by eliminating production processes, which may extend the life of electronic devices and thereby reducing electronic waste, among other benefits.

Features of the disclosure are illustrated and described in the context of systems and architectures. Features of the disclosure are further illustrated and described in the context of data correction configuration, reconfiguration diagrams, process flows, and flowcharts.

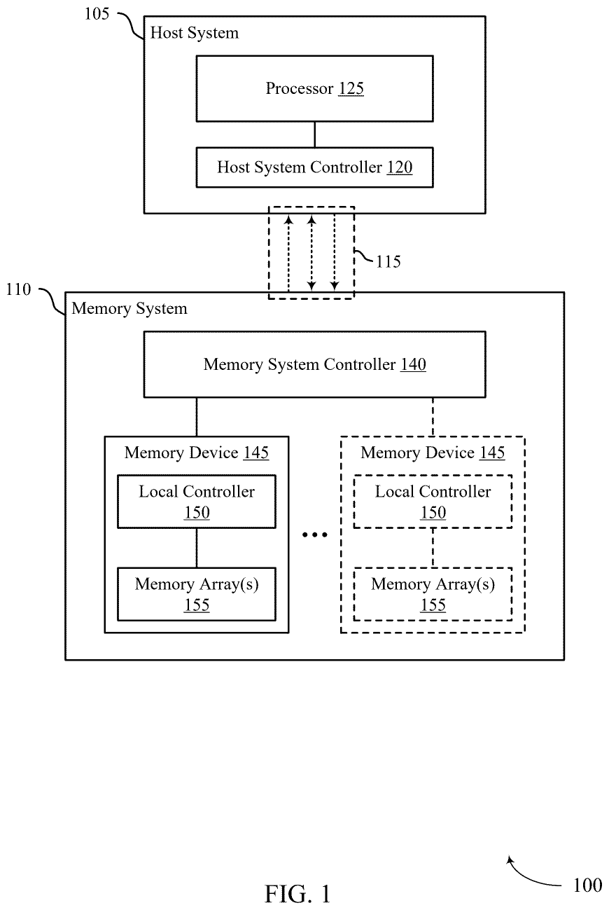

FIG. 1 shows an example of a system 100 that supports dynamic reconfiguration of error control operations in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

The memory system 110 may be configured to dynamically reconfigure its error control capabilities. For example, the memory system 110 may configure ranks (e.g., regions of memory dies) to operate according to a SDDC capability. In the case that the memory system 110 determines that a memory die associated with a virtual bank of one of the ranks includes an error, the memory system 110 (e.g., the memory system controller 140) may reconfigure one or more virtual banks (e.g., two virtual banks in total) to operate according to a DDDC capability. In other examples, if the memory system determines that multiple memory dies (e.g., configured using a DDDC capability) include errors, the memory system may reconfigure two or more additional virtual banks (e.g., four virtual banks in total) to operate according to a QDDC capability. By dynamically reconfiguring virtual banks of the memory system 110 in response to detecting errors at associated memory dies, the memory system 110 may increase its ability to detect and correct errors, while also maintaining a relatively higher bandwidth and overall performance.

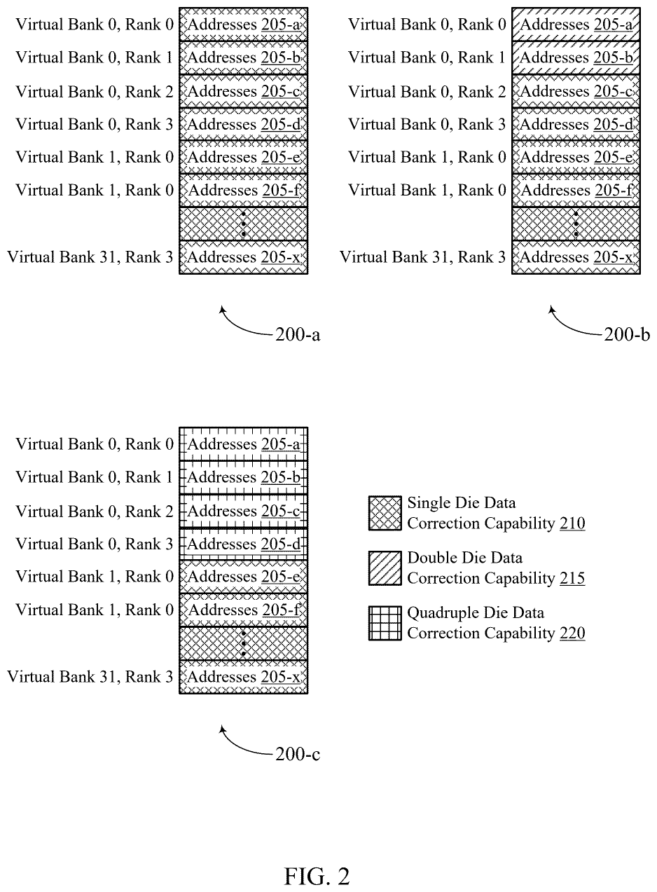

FIG. 2 illustrates examples of a block diagram 200 that supports dynamic reconfiguration of error control operations in accordance with examples as disclosed herein. The block diagram 200 may be implemented by aspects of a memory system 110 or one or more components thereof (e.g., a memory device 145), as described with reference to FIG. 1.

For example, the memory system may include a plurality of memory dies (e.g., a plurality of memory devices 145 as described with reference to FIG. 1) that each include respective arrays of memory cells (e.g., memory array(s) 155 as described with reference to FIG. 1). In some instances, the plurality of memory dies may be arranged in one or more ranks, where a rank refers to a set of memory arrays coupled with a same chip select signal (e.g., and therefore can be accessed simultaneously). Each rank may also be coupled with a respective data bus. For example, a rank may consist of a portion of memory arrays from ten (10) memory dies (e.g., memory die 0 through memory die 9) and may be associated with one or more virtual banks that each span the entirety of a rank. Each virtual bank may include portions of the memory dies included in the respective ranks. For example, a first virtual bank may include portions of each memory die included in a first rank. Additionally, or alternatively, each rank may consist of data dies (e.g., memory dies for storing data) and parity dies (e.g., memory dies for storing parity information). In some instances, a rank may include eight (8) data dies and two (2) parity dies.

In some examples, each rank may be associated with a set of addresses 205. Each address of a set of addresses 205 may be associated with a memory die of the rank. For example, a first address of the set of addresses 205-a may be associated with a first memory die of a first rank (e.g., Rank 0). Additionally, or alternatively, the first address of the set of addresses 205-a may be associated with a first virtual bank of the first rank (e.g., Virtual Bank 0, Rank 0).

The memory system may implement ECCs to perform error control operations at memory dies of the memory system. For example, one or more memory devices or controllers of the memory system may be configured with error control capabilities (e.g., an SDDC capability 210, a DDDC capability 215, a QDDC capability 220) to correct errors that may occur when reading data from and writing data to memory dies of the memory system. In some examples, the memory system may include an error control component that may perform the error control operations at the memory dies. The memory system (e.g., or a component thereof) may be configured according to an SDDC capability 210. If configured according to the SDDC capability 210, the memory system may use an SDDC code (e.g., a Reed-Solomon code) to correct data errors of a single die associated with a codeword of the memory system. In the case that the memory system may be associated with a fixed error control operation that uses SDDC codes, the memory system may be unable to perform error control operations in the case additional errors are detected in a different memory die of the codeword.

The memory system may be configured with error control capabilities associated with more ECC coverage, such as according to the DDDC capability 215 or the QDDC capability 220, but these higher-coverage (e.g., greater) error control capabilities may decrease efficiency of the memory system. For example, the memory system (e.g., or a component thereof) may be configured according to the DDDC capability 215. If configured according to the DDDC capability 215, the memory system may be configured to use a DDDC code and a relatively-larger codeword (e.g., associated with two virtual banks, associated with virtual banks of two ranks) to correct errors associated with two memory dies. In some examples, the memory system may be configured according to the QDDC capability 220. If configured according to the QDDC capability 220, the memory system may be configured to use a QDDC code and a relatively-largest codeword (e.g., associated with four virtual banks, associated with virtual banks of four ranks) to correct errors associated with four memory dies. While implementation of a fixed error control operation that uses DDDC or QDDC codes may decrease errors at memory dies of the memory system, use of a DDDC or QDDC code and the associated large codewords may be associated with a large, negative impact on the performance of the memory system due to decreased bandwidth.

To increase effectiveness of error control operations while retaining relatively higher performance, the memory system may be configured to dynamically change the error control capability of various virtual banks. For example, the memory system (e.g., or a component thereof) may initially configure the ranks of the memory system to operate according to the SDDC capability 210. As depicted in data correction configuration 200a, the virtual banks of the ranks associated with the sets of addresses 205 may be configured according to the SDDC capability 210. The memory system may perform access operations and error control operations at the virtual banks (e.g., the memory dies associated with the virtual banks) associated with the sets of addresses 205 according to the SDDC capability 210 until the memory system detects an error at a memory die of one of the associated virtual banks.

In a case that the memory system determines that a memory die of one of the virtual banks associated with the sets of addresses 205 includes an error, the memory system may reconfigure the virtual bank of the rank that includes the memory die (e.g., the memory die experiencing the error) along with a second virtual bank of a second rank to operate according to the DDDC capability 215. For example, the memory system may access the set of addresses 205-a and may determine that a memory die associated with the set of addresses 205-a (e.g., associated with Virtual Bank 0, Rank 0) includes an error (e.g., is defective). Based on the set of addresses 205-a being configured according to the SDDC capability 210 at the time of the access operation and based on the set of addresses 205-a being located in Virtual Bank 0 of Rank 0 of the memory system, the memory system may reconfigure Virtual Bank 0 of Rank 0 and the corresponding virtual bank (e.g., Virtual Bank 0) of an adjacent rank (e.g., Rank 1) according to the DDDC capability 215. As depicted in data correction configuration 200-b, the virtual banks associated with the set of addresses 205-a and the set of addresses 205-b may be configured according to the DDDC capability 215.

In some instances, when reconfiguring a virtual bank of a rank from a SDDC capability to a DDDC capability, a corresponding virtual bank of an adjacent rank may also be reconfigured to a DDDC capability due to an access size of data communicated with a host. For example, data may be communicated with a host in multiples of 64 B. Increasing the error control capability of a single virtual bank of a rank (e.g., Virtual Bank 0, Rank 0) may violate the data access size requirements, thus when reconfiguring a virtual bank of a rank from a SDDC capability to a DDDC capability, a corresponding virtual bank of an adjacent rank may also be reconfigured to a DDDC capability (e.g., Virtual Bank 0, Rank 1 may also be reconfigured).

After reconfiguring Virtual Bank 0 of Rank 0 and Virtual Bank 0 of Rank 1 according to the DDDC capability 215, the memory system may perform access operations and error control operations at the memory dies associated with the set of addresses 205-a and the set of addresses 205-b according to the DDDC capability 215 and may perform access operations and error control operations at the memory dies associated with the remaining sets of addresses 205 (e.g., at a set of addresses 205-c through a set of addresses 205-x, at all sets of addresses 205 configured according to the SDDC capability 210) according to the SDDC capability 210 until the memory system detects a second error at a second memory die associated with the first virtual bank (e.g., Virtual Bank 0).

After reconfiguring the ranks associated with the set of addresses 205-a and the set of addresses 205-b, the memory system may detect another error at a second memory die of the associated virtual bank. For example, the memory system may access a second memory die associated with the set of addresses 205-a (e.g., associated with the Virtual Bank 0), and may determine that the second memory die includes an error (e.g., is defective). Based on the set of addresses 205-a being configured according to the DDDC capability 215 at the time of the access operation (e.g., based on a first memory die of the “Virtual Bank 0” also being defective) and based on the set of addresses 205-a being located in Virtual Bank 0 of Rank 0 of the memory system, the memory system may reconfigure Virtual Bank 0 and the corresponding virtual banks (e.g., Virtual Bank 0) of three other ranks (e.g., Rank 1, Rank 2, and Rank 3) according to the QDDC capability 220. As depicted in data correction configuration 200-c, the ranks associated with the set of addresses 205-a, the set of addresses 205-b, the set of addresses 205-c, and the set of addresses 205-d may be configured according to the QDDC capability 220.

After reconfiguring a corresponding virtual bank of Rank 0, Rank 1, Rank 2, and Rank 3 according to the QDDC capability 220, the memory system may perform access operations and error control operations at the memory dies associated with the set of addresses 205-a, the set of addresses 205-b, the set of addresses 205-c, and the set of addresses 205-d according to the QDDC capability 220 and may perform access operations and error control operations at the memory dies associated with the remaining sets of addresses 205 (e.g., at a set of addresses 205-e, a set of addresses 205-f, through a set of addresses 205-x, at all sets of addresses 205 configured according to the SDDC capability 210) according to the SDDC capability 210.

Each time the memory system reconfigures the virtual banks of ranks, an associated codeword may be spread across each of the reconfigured virtual banks (e.g., and associated ranks). Additionally, or alternatively, each time the memory system reconfigures a virtual bank of a rank, the channels associated with the reconfigured rank may be grouped together (e.g., act as one channel) for the associated virtual banks. Additionally, or alternatively, while the examples herein describe reconfiguration from the SDDC capability 210 to the DDDC capability 215 to the QDDC capability 220, the memory system may be configured to dynamically choose which of the capabilities to reconfigure the virtual banks of a rank according to (e.g., the memory system may reconfigure according to a different order to capabilities). After each reconfiguration event, the memory system may store a location associated with the reconfigured addresses of each virtual bank within non-volatile memory of the memory system (e.g., within an ECC table, as described herein) such that the memory system may access the location information during a boot-up operation.

In some examples, the memory system may reconfigure virtual bank based on a quantity of data channel failures associated with a memory die reaching a threshold. For example, the memory system may reconfigure one or more virtual banks associated with a memory die (e.g., associated with the set of addresses 205-a, as described herein) from the SDDC capability 210 to the DDDC capability 215 based on determining that an error may be affecting a quantity of (e.g., or all) data channels (e.g., DQs) of the memory die that satisfies the threshold. The memory system may reconfigure one or more virtual banks associated with two memory dies (e.g., associated with the set of addresses 205-a, as described herein) from the SDDC capability 210 and the DDDC capability 215 to the QDDC capability 220 based on determining that an error may be affecting a quantity of (e.g., or all) data channels (e.g., DQs) of the memory dies that satisfies the threshold (or a different threshold).

In some examples, the memory system may reconfigure varying granularities of memory. For example, rather than reconfiguring virtual banks in response to determining errors at memory dies, the memory system may reconfigure ranks of the memory system in response to determining errors at associated memory dies. Additionally, or alternatively, the memory system may reconfigure banks of a memory die in response to determining an error at one of the banks of the memory die.

By enabling the memory system to dynamically reconfigure various virtual banks of ranks in response to detecting errors at associated memory dies, the memory system may increase the overall error control capabilities of the memory system while maintaining its performance. For example, in the case that the memory system reconfigures one or more memory dies associated with one or more of a set of addresses 205, the performance of the memory system may be less impacted than if a larger portion of the set of addresses 205 is reconfigured. In the case that the memory system reconfigures one or more ranks of a virtual bank, the error control capabilities may be relatively simple for the memory system to track and implement. Dynamic reconfiguration may allow the memory system to choose a balance between error control capabilities and performance of the memory system.

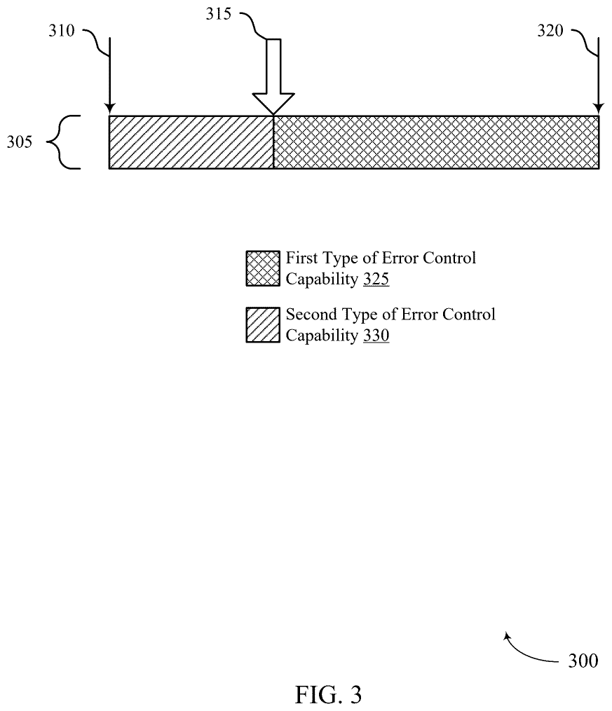

FIG. 3 shows an example of a block diagram 300 that supports dynamic reconfiguration of error control operations in accordance with examples as disclosed herein. The block diagram 300 may be implemented by aspects of a memory system 110 or one or more components thereof (e.g., a memory device 145), as described with reference to FIG. 1. The block diagram 300 may include examples of aspects of the block diagram 200 as described with reference to FIG. 2. For example, the block diagram 300 may include a set of addresses 305, which may be an example of a set of addresses 205 as illustrated in FIG. 2. For example, the set of addresses 305 may be associated with a set of memory dies associated with a virtual bank of a rank of the memory system as described herein.

The memory system may include a reconfiguration cursor 315 for use during reconfiguration operations on each set of addresses 305 included in the memory system. For example, the set of addresses 305 may initially be configured according to the first type of error control capability 325, which may be SDDC. In response to determining an error at a memory die associated with an address of the set of addresses 305, the memory system may reconfigure the set of addresses according to the second type of error control capability 330, which may be DDDC. The memory system may begin reconfiguring the set of addresses 305 at a first address 310 of the set of addresses 305, and may reconfigure each address of the set of addresses 305 through the last address 320 of the set of addresses 305. For each address the memory system reconfigures, the memory system may move the reconfiguration cursor 315 to point to the most recent address to be reconfigured or the address at which a reconfiguration operation is occurring. For example, after reconfiguring the first address 310, the memory system may set the reconfiguration cursor 315 to the address of the set of addresses 305 that is adjacent to the first address 310.

To reconfigure an address of the set of addresses 305, the memory system may read data from the address from the set of addresses 305. In the case that the address may be located before the reconfiguration cursor 315 (e.g., located to the left of the reconfiguration cursor 315 as illustrated in the block diagram 300), the memory system may read the data according to the second type of error control capability 330. In the case that the address may be located after the reconfiguration cursor 315 (e.g., located to the right of the reconfiguration cursor 315 as illustrated in the block diagram 300), the memory system may read the data according to the first type of error control capability 325. The memory system may rewrite the data to the same address according to a different capability. For example, in the case that the memory system reads the data according to the first type of error control capability 325, the memory system may write the data to the same address according to the second type of error control capability 330. In the case that the memory system reads the data according to the second type of error control capability 330, the memory system may write the data to the same address according to a QDDC capability (e.g., as further described herein).

The memory system may write (e.g., save) the ECC associated with the reconfiguration in an ECC table (e.g., not illustrated). In response to rewriting data to an address according to a new ECC, the memory system may write the new ECC code to the ECC table. For example, after reconfiguring the first address 310 according to the second type of error control capability 330, the memory system may write an indication of the second type of error control capability 330 in the ECC table in a location associated with the first address 310. In some examples, the memory system may access the indication stored to the ECC table to determine the current configuration of the address in future reconfiguration operations.

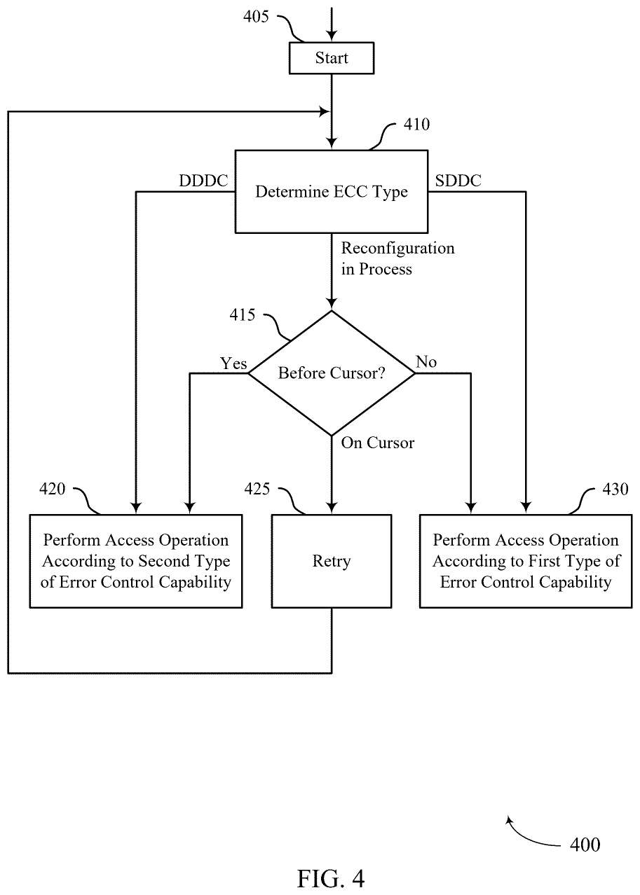

FIG. 4 shows an example of a process flow 400 that supports dynamic reconfiguration of error control operations in accordance with examples as disclosed herein. The operations of process flow 400 may be performed by a memory system or one or more controllers associated with a memory system as described herein. The process flow 400 may also include reference to an SDDC capability, a DDDC capability, and a QDDC capability of the memory system as described herein. The process flow 400 may be an example of an access operation at an address of the memory system.

At 405, the memory system may begin performing an access operation on an address of a set of address (e.g., as further described herein). The memory system may perform the access operation in response to receiving a command to access the address (e.g., from a host system).

At 410, the memory system may determine the ECC type of the address. For example, the memory system may access an indication of the address in an ECC table of the memory system. In the case that the memory system may determine (e.g., based on the ECC table indication) that the address is configured according to the SDDC capability, the memory system may perform the access operation on the address according to the SDDC capability at 430.

In the case that the memory system may determine (e.g., based on the ECC table indication) that the address is configured according to the DDDC capability, the memory system may perform the access operation on the address according to the DDDC capability at 420. Thus, the memory system may perform an access operation (e.g., a read operation, a write operation) according to the determined ECC capability at 420 or 430.

In some examples, the memory system may determine that the ECC type of the address is a combination of the SDDC capability and the DDDC capability, which may indicate that the address is being reconfigured by the memory system. In response to determining that a reconfiguration process may be occurring at the address, the memory system may determine (e.g., at 415) whether the address is located before the reconfiguration cursor in the set of addresses.

At 415, the memory system may determine the location of the address relative to the reconfiguration cursor. For example, the memory system may locate the reconfiguration cursor and compare an address pointed to by the reconfiguration cursor to the address. In the case that the memory system may determine the address to be located before the reconfiguration cursor (e.g., before an address associated with the reconfiguration cursor), the memory system may perform the access operation on the address according to the DDDC capability at 420. In the case that the memory system may determine the address to be located after the reconfiguration cursor (e.g., determine the address to be located after the reconfiguration cursor), the memory system may perform the access operation on the address according to the SDDC capability at 420. In some examples, the memory system may determine the address to be located at the reconfiguration cursor (e.g., determine the address to be the address associated with the reconfiguration cursor), the memory system may thus retry the process flow starting at 425.

At 425, the memory system may begin retrying an access operation on the address. In the case the ECC table may include an example of a probabilistic structure (e.g., a bloom filter), the ECC table may output an indication of the ECC type in probabilities. For example, the ECC table may output (e.g., at 410) an indication that the address might be associated with the DDDC capability or might be associated with the SDDC capability (e.g., rather than certainly being associated with the DDDC capability or the SDDC capability). In some examples, the memory system may not be configured to perform operations on an address that “might” be associated with a capability, as the uncertainty of the capability may indicate a false positive or a false negative. Rather than perform access operations according to a wrong capability, the memory system may perform additional operations to decrease errors associated with determining the ECC type (e.g., the capability) associated with an address. For example, the memory system may perform a read operation according to the DDDC capability prior to performing write operations (e.g., according to the DDDC capability) to determine whether the DDDC capability is correct or not. To avoid generating an uncorrectable error at the address, the memory system may retry the access operation (e.g., moving to 410).

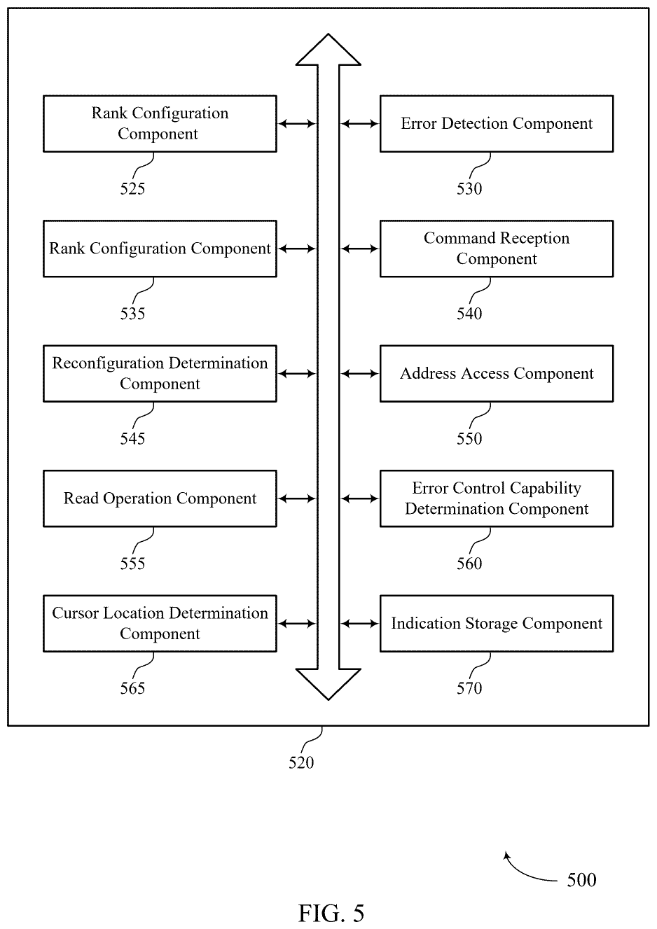

FIG. 5 shows a block diagram 500 of a memory system 520 that supports dynamic reconfiguration of error control operations in accordance with examples as disclosed herein. The memory system 520 may be an example of aspects of a memory system as described with reference to FIGS. 1 through 4. The memory system 520, or various components thereof, may be an example of means for performing various aspects of dynamic reconfiguration of error control operations as described herein. For example, the memory system 520 may include a rank configuration component 525, an error detection component 530, a rank configuration component 535, a command reception component 540, a reconfiguration determination component 545, an address access component 550, a read operation component 555, an error control capability determination component 560, a cursor location determination component 565, an indication storage component 570, or any combination thereof. Each of these components, or components of subcomponents thereof (e.g., one or more processors, one or more memories), may communicate, directly or indirectly, with one another (e.g., via one or more buses).

The rank configuration component 525 may be configured as or otherwise support a means for configuring a plurality of ranks associated with a plurality of memory dies of the memory system to operate in accordance with a first error control capability of a plurality of error control capabilities. The error detection component 530 may be configured as or otherwise support a means for determining an occurrence of a correctable error associated with a memory die of a first virtual bank of a first rank while operating the plurality of ranks in accordance with the first error control capability. The rank configuration component 535 may be configured as or otherwise support a means for configuring the first virtual bank of the first rank and a second virtual bank of a second rank of the plurality of ranks to operate in accordance with a second error control capability of the plurality of error control capabilities that is greater than the first error control capability based on determining the occurrence of the correctable error.

In some examples, the error detection component 530 may be configured as or otherwise support a means for determining an occurrence of a second correctable error associated with a second memory die associated with the first virtual bank while operating the first virtual bank of the first rank and the second virtual bank of the second rank in accordance with the second error control capability. In some examples, the rank configuration component 535 may be configured as or otherwise support a means for configuring the first virtual bank of the first rank, the second virtual bank of the second rank, a third virtual bank of a third rank, and a fourth virtual bank of a fourth rank to operate in accordance with a third error control capability of the plurality of error control capabilities that is greater than the first error control capability and the second error control capability based on determining the occurrence of the second correctable error.

In some examples, the read operation component 555 may be configured as or otherwise support a means for reading data from an address associated with the first virtual bank of the first rank and an address associated with the second virtual bank of the second rank, where determining the occurrence of the second correctable error is based on reading the data.

In some examples, the first error control capability is associated with an SDDC code; the second error control capability is associated with a DDDC code; and the third error control capability is associated with a QDDC code.

In some examples, the read operation component 555 may be configured as or otherwise support a means for reading data from an address associated with the first virtual bank of the first rank, where determining the occurrence of the correctable error is based on reading the data.

In some examples, the first rank and the second rank are associated with a codeword.

In some examples, the address access component 550 may be configured as or otherwise support a means for accessing a first address of the first virtual bank according to the first error control capability based on configuring the first virtual bank of the first rank of the plurality of ranks of the memory system to operate in accordance with the first error control capability, where determining the occurrence of the correctable error associated with the memory die associated with the first virtual bank is based on accessing the first address.

In some examples, the address access component 550 may be configured as or otherwise support a means for accessing a second address of the second virtual bank according to the second error control capability based on configuring the first virtual bank of the first rank and the second virtual bank of the second rank to operate in accordance with the second error control capability.

In some examples, a fifth virtual bank of a fifth rank and a sixth virtual bank of a sixth rank of the plurality of ranks are configured to operate in accordance with the first error control capability based on configuring the first virtual bank of the first rank and the second virtual bank of the second rank in accordance with the second error control capability.

The command reception component 540 may be configured as or otherwise support a means for receiving a command for accessing an address of a first virtual bank of the memory system, where the address is associated with the first virtual bank. The reconfiguration determination component 545 may be configured as or otherwise support a means for determining, in accordance with receiving the command, whether the first virtual bank is being reconfigured from operating using a first error control capability to operating using a second error control capability. The address access component 550 may be configured as or otherwise support a means for accessing the address of the first virtual bank according to the first error control capability or the second error control capability based on the first virtual bank being configured and a location of a cursor.

In some examples, the error control capability determination component 560 may be configured as or otherwise support a means for determining a type of error control capability associated with data stored to the address of the first virtual bank based on determining that the first virtual bank is not being reconfigured, where accessing the address accessing the address of the first virtual bank according to the first error control capability or the second error control capability is based on determining the type of the error control capability.

In some examples, the cursor location determination component 565 may be configured as or otherwise support a means for determining that a starting location of the address is before the cursor. In some examples, the address access component 550 may be configured as or otherwise support a means for accessing the address of the first virtual bank according to the second error control capability based on the starting location of the address being before the cursor.

In some examples, the cursor location determination component 565 may be configured as or otherwise support a means for determining that a starting location of the address is after the cursor. In some examples, the address access component 550 may be configured as or otherwise support a means for accessing the address of the first virtual bank according to the first error control capability based on the starting location of the address being after the cursor.

In some examples, the indication storage component 570 may be configured as or otherwise support a means for storing an indication that the first virtual bank is associated with the second error control capability based on determining that the first virtual bank has been reconfigured.

In some examples, the first error control capability is associated with an SDDC code; the second error control capability is associated with a DDDC code; and a third error control capability is associated with a QDDC code.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

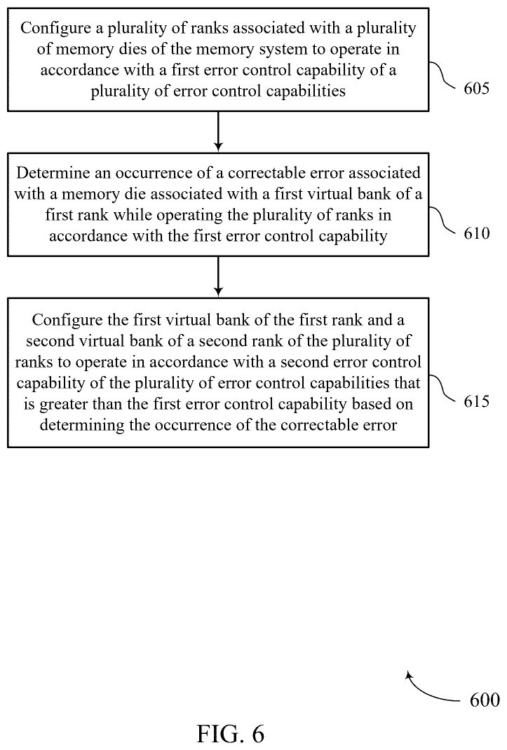

FIG. 6 shows a flowchart illustrating a method 600 that supports dynamic reconfiguration of error control operations in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include configuring a plurality of ranks of the memory system to operate in accordance with a first error control capability of a plurality of error control capabilities. In some examples, aspects of the operations of 605 may be performed by a rank configuration component 525 as described with reference to FIG. 5. For example, the memory system may configure ranks of a virtual bank associated with sets of addresses 205 (e.g., the set of addresses 305) to operate according to the SDDC capability 210 (e.g., the first type of error control capability 325) as described herein, including with reference to FIGS. 2 and 3.

At 610, the method may include determining an occurrence of a correctable error associated with a memory die of a first virtual bank of a first rank while operating the plurality of ranks in accordance with the first error control capability. In some examples, aspects of the operations of 610 may be performed by an error detection component 530 as described with reference to FIG. 5. For example, the memory system may determine a memory die associated with an address of the sets of addresses 205 (e.g., the set of addresses 305) may include an error as described herein, including with reference to FIG. 2.

At 615, the method may include configuring the first virtual bank of the first rank and a second virtual bank of a second rank of the plurality of ranks to operate in accordance with a second error control capability of the plurality of error control capabilities that is greater than the first error control capability based on determining the occurrence of the correctable error. In some examples, aspects of the operations of 615 may be performed by a rank configuration component 535 as described with reference to FIG. 5. For example, the memory system may reconfigure the rank associated with the memory die, and an adjacent rank, to operate according to the DDDC capability 215 (e.g., the second type of error control capability 330) as described herein, including with reference to FIGS. 2 and 3.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for configuring a plurality of ranks associated with a plurality of memory dies of the memory system to operate in accordance with a first error control capability of a plurality of error control capabilities; determining an occurrence of a correctable error associated with a memory die of a first virtual bank of a first rank while operating the plurality of ranks in accordance with the first error control capability; and configuring the first virtual bank of the first rank and a second virtual bank of a second rank of the plurality of ranks to operate in accordance with a second error control capability of the plurality of error control capabilities that is greater than the first error control capability based on determining the occurrence of the correctable error.

Aspect 2: The method, apparatus, or non-transitory computer-readable medium of aspect 1, further including operations, features, circuitry, logic, means, or instructions, or any combination thereof for determining an occurrence of a second correctable error associated with a second memory die associated with the first virtual bank while operating the first virtual bank of the first rank and the second virtual bank of the second rank in accordance with the second error control capability and configuring the first virtual bank of the first rank, the second virtual bank of the second rank, a third virtual bank of a third rank, and a fourth virtual bank of a fourth rank to operate in accordance with a third error control capability of the plurality of error control capabilities that is greater than the first error control capability and the second error control capability based on determining the occurrence of the second correctable error.

Aspect 3: The method, apparatus, or non-transitory computer-readable medium of aspect 2, further including operations, features, circuitry, logic, means, or instructions, or any combination thereof for reading data from an address associated with the first virtual bank of the first rank and an address associated with the second virtual bank of the second rank, where determining the occurrence of the second correctable error is based on reading the data.

Aspect 4: The method, apparatus, or non-transitory computer-readable medium of any of aspects 1 through 3, where the first error control capability is associated with an SDDC code; the second error control capability is associated with a DDDC code; and the third error control capability is associated with a QDDC code.

Aspect 5: The method, apparatus, or non-transitory computer-readable medium of any of aspects 1 through 4, further including operations, features, circuitry, logic, means, or instructions, or any combination thereof for reading data from an address associated with the first virtual bank of the first rank, where determining the occurrence of the correctable error is based on reading the data.

Aspect 6: The method, apparatus, or non-transitory computer-readable medium of any of aspects 1 through 5, where the first rank and the second rank are associated with a codeword.

Aspect 7: The method, apparatus, or non-transitory computer-readable medium of any of aspects 1 through 6, further including operations, features, circuitry, logic, means, or instructions, or any combination thereof for accessing a first address of the first virtual bank according to the first error control capability based on configuring the first virtual bank of the first rank of the plurality of ranks of the memory system to operate in accordance with the first error control capability, where determining the occurrence of the correctable error associated with the memory die associated with the first virtual bank is based on accessing the first address.

Aspect 8: The method, apparatus, or non-transitory computer-readable medium of aspect 7, further including operations, features, circuitry, logic, means, or instructions, or any combination thereof for accessing a second address of the second virtual bank according to the second error control capability based on configuring the first virtual bank of the first rank and the second virtual bank of the second rank to operate in accordance with the second error control capability.

Aspect 9: The method, apparatus, or non-transitory computer-readable medium of any of aspects 1 through 8, where a fifth virtual bank of a fifth rank and a sixth virtual bank of a sixth rank of the plurality of ranks are configured to operate in accordance with the first error control capability based on configuring the first virtual bank of the first rank and the second virtual bank of the second rank in accordance with the second error control capability.

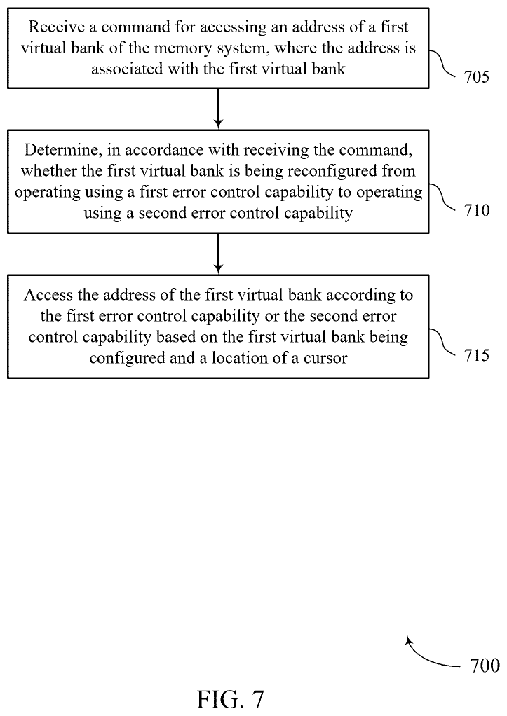

FIG. 7 shows a flowchart illustrating a method 700 that supports dynamic reconfiguration of error control operations in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving a command for accessing an address of a first virtual bank of the memory system, where the address is associated with the first virtual bank. In some examples, aspects of the operations of 705 may be performed by a command reception component 540 as described with reference to FIG. 5. For example, the memory system may receive a command to access an address of a set of addresses 205 (e.g., the set of addresses 305)—as described herein, including with reference to FIGS. 2, 3, and 4.

At 710, the method may include determining, in accordance with receiving the command, whether the first virtual bank is being reconfigured from operating using a first error control capability to operating using a second error control capability. In some examples, aspects of the operations of 710 may be performed by a reconfiguration determination component 545 as described with reference to FIG. 5. For example, the memory system may determine whether the address is being reconfigured by accessing the reconfiguration cursor 315—as described herein, including with reference to FIGS. 2, 3, and 4.

At 715, the method may include accessing the address of the first virtual bank according to the first error control capability or the second error control capability based on the first virtual bank being configured and a location of a cursor. In some examples, aspects of the operations of 715 may be performed by an address access component 550 as described with reference to FIG. 5. For example, the memory system may access the address according to the DDDC capability 215 (e.g., the second type of error control capability 330)—as described herein, including with reference to FIGS. 2, 3, and 4.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving a command for accessing an address of a first virtual bank of the memory system, where the address is associated with the first virtual bank; determining, in accordance with receiving the command, whether the first virtual bank is being reconfigured from operating using a first error control capability to operating using a second error control capability; and accessing the address of the first virtual bank according to the first error control capability or the second error control capability based on the first virtual bank being configured and a location of a cursor.

Aspect 11: The method, apparatus, or non-transitory computer-readable medium of aspect 10, further including operations, features, circuitry, logic, means, or instructions, or any combination thereof for determining a type of error control capability associated with data stored to the address of the first virtual bank based on determining that the first virtual bank is not being reconfigured, where accessing the address accessing the address of the first virtual bank according to the first error control capability or the second error control capability is based on determining the type of the error control capability.

Aspect 12: The method, apparatus, or non-transitory computer-readable medium of any of aspects 10 through 11, further including operations, features, circuitry, logic, means, or instructions, or any combination thereof for determining that a starting location of the address is before the cursor and accessing the address of the first virtual bank according to the second error control capability based on the starting location of the address being before the cursor.

Aspect 13: The method, apparatus, or non-transitory computer-readable medium of any of aspects 10 through 12, further including operations, features, circuitry, logic, means, or instructions, or any combination thereof for determining that a starting location of the address is after the cursor and accessing the address of the first virtual bank according to the first error control capability based on the starting location of the address being after the cursor.

Aspect 14: The method, apparatus, or non-transitory computer-readable medium of any of aspects 10 through 13, further including operations, features, circuitry, logic, means, or instructions, or any combination thereof for storing an indication that the first virtual bank is associated with the second error control capability based on determining that the first virtual bank has been reconfigured.

Aspect 15: The method, apparatus, or non-transitory computer-readable medium of any of aspects 10 through 14, where the first error control capability is associated with an SDDC code; the second error control capability is associated with a DDDC code; and a third error control capability is associated with a QDDC code.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
configure a plurality of ranks associated with a plurality of memory dies of the memory system to operate in accordance with a first error control capability of a plurality of error control capabilities;
determine an occurrence of a correctable error associated with a memory die of a first virtual bank of a first rank while operating the plurality of ranks in accordance with the first error control capability; and
configure the first virtual bank of the first rank and a second virtual bank of a second rank of the plurality of ranks to operate in accordance with a second error control capability of the plurality of error control capabilities that is greater than the first error control capability based on determining the occurrence of the correctable error.

2. The memory system of claim 1, wherein the processing circuitry is further configured to cause the memory system to:
determine an occurrence of a second correctable error associated with a second memory die associated with the first virtual bank while operating the first virtual bank of the first rank and the second virtual bank of the second rank in accordance with the second error control capability; and
configure the first virtual bank of the first rank, the second virtual bank of the second rank, a third virtual bank of a third rank, and a fourth virtual bank of a fourth rank to operate in accordance with a third error control capability of the plurality of error control capabilities that is greater than the first error control capability and the second error control capability based on determining the occurrence of the second correctable error.

3. The memory system of claim 2, wherein the processing circuitry is further configured to cause the memory system to:
read data from an address associated with the first virtual bank of the first rank and an address associated with the second virtual bank of the second rank, wherein determining the occurrence of the second correctable error is based on reading the data.

4. The memory system of claim 2, wherein:
the first error control capability is associated with a single die data correction (SDDC) code;
the second error control capability is associated with a double die data correction (DDDC) code; and
the third error control capability is associated with a quad die data correction (QDDC) code.

5. The memory system of claim 1, wherein the processing circuitry is further configured to cause the memory system to:
read data from an address associated with the first virtual bank of the first rank, wherein determining the occurrence of the correctable error is based on reading the data.

6. The memory system of claim 1, wherein the first rank and the second rank are associated with a codeword.

7. The memory system of claim 1, wherein the processing circuitry is further configured to cause the memory system to:
access a first address of the first virtual bank according to the first error control capability based on configuring the first virtual bank of the first rank of the plurality of ranks of the memory system to operate in accordance with the first error control capability, wherein determining the occurrence of the correctable error associated with the memory die associated with the first virtual bank is based on accessing the first address.

8. The memory system of claim 7, wherein the processing circuitry is further configured to cause the memory system to:
access a second address of the second virtual bank according to the second error control capability based on configuring the first virtual bank of the first rank and the second virtual bank of the second rank to operate in accordance with the second error control capability.

9. The memory system of claim 1, wherein a fifth virtual bank of a fifth rank and a sixth virtual bank of a sixth rank of the plurality of ranks are configured to operate in accordance with the first error control capability based on configuring the first virtual bank of the first rank and the second virtual bank of the second rank in accordance with the second error control capability.

10. A memory system, comprising:
one or more memory devices; and
processing circuitry coupled with the one or more memory devices and configured to cause the memory system to:
receive a command for accessing an address of a first virtual bank of the memory system, wherein the address is associated with the first virtual bank;
determine, in accordance with receiving the command, whether the first virtual bank is being reconfigured from operating using a first error control capability to operating using a second error control capability; and
access the address of the first virtual bank according to the first error control capability or the second error control capability based on the first virtual bank being configured and a location of a cursor.

11. The memory system of claim 10, wherein the processing circuitry is further configured to cause the memory system to:
determine a type of error control capability associated with data stored to the address of the first virtual bank based on determining that the first virtual bank is not being reconfigured, wherein accessing the address accessing the address of the first virtual bank according to the first error control capability or the second error control capability is based on determining the type of the error control capability.

12. The memory system of claim 10, wherein the processing circuitry is further configured to cause the memory system to:
determine that a starting location of the address is before the cursor; and
access the address of the first virtual bank according to the second error control capability based on the starting location of the address being before the cursor.

13. The memory system of claim 10, wherein the processing circuitry is further configured to cause the memory system to:
determine that a starting location of the address is after the cursor; and
access the address of the first virtual bank according to the first error control capability based on the starting location of the address being after the cursor.

14. The memory system of claim 10, wherein the processing circuitry is further configured to cause the memory system to:
store an indication that the first virtual bank is associated with the second error control capability based on determining that the first virtual bank has been reconfigured.

15. The memory system of claim 10, wherein:
the first error control capability is associated with a single die data correction (SDDC) code;
the second error control capability is associated with a double die data correction (DDDC) code; and
a third error control capability is associated with a quad die data correction (QDDC) code.

16. A method at a memory system, comprising:
configuring a plurality of ranks associated with a plurality of memory dies of the memory system to operate in accordance with a first error control capability of a plurality of error control capabilities;
determining an occurrence of a correctable error associated with a memory die of a first virtual bank of a first rank while operating the plurality of ranks in accordance with the first error control capability; and
configuring the first virtual bank of the first rank and a second virtual bank of a second rank of the plurality of ranks to operate in accordance with a second error control capability of the plurality of error control capabilities that is greater than the first error control capability based on determining the occurrence of the correctable error.

17. The method of claim 16, further comprising:
determining an occurrence of a second correctable error associated with a second memory die associated with the first virtual bank while operating the first virtual bank of the first rank and the second virtual bank of the second rank in accordance with the second error control capability; and
configuring the first virtual bank of the first rank, the second virtual bank of the second rank, a third virtual bank of a third rank, and a fourth virtual bank of a fourth rank to operate in accordance with a third error control capability of the plurality of error control capabilities that is greater than the first error control capability and the second error control capability based on determining the occurrence of the second correctable error.

18. The method of claim 17, further comprising:
reading data from an address associated with the first virtual bank of the first rank and an address associated with the second virtual bank of the second rank, wherein determining the occurrence of the second correctable error is based on reading the data.

19. The method of claim 17, wherein:
the first error control capability is associated with a single die data correction (SDDC) code;
the second error control capability is associated with a double die data correction (DDDC) code; and
the third error control capability is associated with a quad die data correction (QDDC) code.

20. The method of claim 16, further comprising:
reading data from an address associated with the first virtual bank of the first rank, wherein determining the occurrence of the correctable error is based on reading the data.

21. The method of claim 16, wherein the first rank and the second rank are associated with a codeword.

22. The method of claim 16, further comprising:
accessing a first address of the first virtual bank according to the first error control capability based on configuring the first virtual bank of the first rank of the plurality of ranks of the memory system to operate in accordance with the first error control capability, wherein determining the occurrence of the correctable error associated with the memory die associated with the first virtual bank is based on accessing the first address.

23. The method of claim 22, further comprising:
accessing a second address of the second virtual bank according to the second error control capability based on configuring the first virtual bank of the first rank and the second virtual bank of the second rank to operate in accordance with the second error control capability.

24. The method of claim 16, wherein a fifth virtual bank of a fifth rank and a sixth virtual bank of a sixth rank of the plurality of ranks are configured to operate in accordance with the first error control capability based on configuring the first virtual bank of the first rank and the second virtual bank of the second rank in accordance with the second error control capability.

25. A method at a memory system, comprising:
receiving a command for accessing an address of a first virtual bank of the memory system, wherein the address is associated with the first virtual bank;
determining, in accordance with receiving the command, whether the first virtual bank is being reconfigured from operating using a first error control capability to operating using a second error control capability; and
accessing the address of the first virtual bank according to the first error control capability or the second error control capability based on the first virtual bank being configured and a location of a cursor.

26. The method of claim 25, further comprising:
determining a type of error control capability associated with data stored to the address of the first virtual bank based on determining that the first virtual bank is not being reconfigured, wherein accessing the address accessing the address of the first virtual bank according to the first error control capability or the second error control capability is based on determining the type of the error control capability.

27. The method of claim 25, further comprising:
determining that a starting location of the address is before the cursor; and
accessing the address of the first virtual bank according to the second error control capability based on the starting location of the address being before the cursor.

28. The method of claim 25, further comprising:
determining that a starting location of the address is after the cursor; and
accessing the address of the first virtual bank according to the first error control capability based on the starting location of the address being after the cursor.

29. The method of claim 25, further comprising:
storing an indication that the first virtual bank is associated with the second error control capability based on determining that the first virtual bank has been reconfigured.

30. A non-transitory computer-readable medium storing code, the code comprising instructions executable by one or more processors to:
configure a plurality of ranks associated with a plurality of memory dies of a memory system to operate in accordance with a first error control capability of a plurality of error control capabilities;
determine an occurrence of a correctable error associated with a memory die of a first virtual bank of a first rank while operating the plurality of ranks in accordance with the first error control capability; and
configure the first virtual bank of the first rank and a second virtual bank of a second rank of the plurality of ranks to operate in accordance with a second error control capability of the plurality of error control capabilities that is greater than the first error control capability based on determining the occurrence of the correctable error.
